(19) United States
(12) Patent Application Publication
(10) Pub. No.: US 2014/0216851 A1
(43) Pub. Date: Aug. 7, 2014

(54) Storage Ladder

(71) Applicant: Andrew Mikesell, Sr., Indianapolis, IN (US)

(72) Inventor: Andrew Mikesell, Sr., Indianapolis, IN (US)

(21) Appl. No.: 13/761,494

(22) Filed: Feb. 7, 2013

(51) Int. Cl. E06C 7/14

(52) U.S. Cl. CPC E06C 7/14
USPC 182/129

(57) ABSTRACT

The present invention relates to a ladder with a design such that storage is incorporated into the ladder body, most notably the rails, by providing for a storage area for tools and other things, which will be incorporated into the manufacture of the ladder. An alternative version is a storage unit approximately the width of the rails of existing ladders, which can be fixedly attached thereto, providing a storage area for tools and other things.

### FIELD OF THE DISCLOSURE

This invention relates to a new design for a ladder that incorporates the ability to store things, including tools, for use by those individuals using the ladder. The present invention is a ladder that takes advantage of the space created by a new design for the ladder uprights (which are called stringers or rails) to enable the storage of items within the ladder, without significantly increasing the amount of space used by the ladder or its weight.

Historically ladders are made up of steps or rungs (for purposes of this application the term “step(s)” will be used throughout), which are attached to vertical elements that are called stringers or rails (for purposes of this application, the term “rail(s)” will be used). The rails are on each end of the steps and provide the ability for weight to be placed on the steps without displacement.

There are generally two kinds of ladders today, stepladders, which are designed to stand on their own, and extension ladders, which are meant to be used by leaning them against something (and of which have no ability to stand on their own). In addition to steps and rails, there are also additional elements that might be seen, such as spreaders in a stepladder, which are the metal bars that include hinges that connect the front and rear rails. Another element also commonly seen on stepladders is a shelf. On extension style ladders you will also see extension locks, which are the locks or hooks that securely hold the two parts of the ladder together at the desired height.

Ladders have been used for thousands of years and Henry Quackenbush even patented the first extension ladder in 1867. The obvious deficiency with the traditional design of ladders is that they provide no means in which to store tools within the confines of the structure of the ladder, to be used by those employing the ladder. This is particularly vexing when you consider that rarely does someone take a journey onto a ladder for the singular reason of checking out the view. Normally there is work to be done and most times this work involves the use of various tools or supplies.

Numerous types of ladders have been provided in the prior art in an attempt to address the issue of storing tools or supplies. For example, U.S. Pat. No. 5,971,102 (Brown); U.S. Pat. No. 5,505,302 (Ferley); U.S. Pat. No. 5,547,080 (Klimas); U.S. Pat. No. 5,603,405 (Smith) and U.S. Pat. No. 5,613,574 (Melanson) are all illustrative, however these inventions are not as suitable for the purposes of the present invention, described herein.

### SUMMARY OF THE INVENTION

The present invention relates to a storage ladder that allows a user access to tools and supplies without the need to leave the ladder. These tools and supplies would also be securely maintained such that the ladder could be moved around without the necessity of removing the tools and/or supplies. This is accomplished by a new design of the rails, which are attached to the steps. This design creates a space that is reachable by the user and can hold tools and supplies. Traditionally, rails have been designed in one of two ways, either as two rails on each side, such as a left-front and left-rear and a right-front and right-rear, while the more common modern design is an integrated rail which wraps slightly around each step toward the middle of the step. This design is meant to take advantage of a box-like cross-section for the rails that provides additional strength and stability.

In the present invention the rails are designed such that the steps are attached to the rails on the ends, with the box-like design being outside the rails versus wrapping around the steps. While this still provides the strength and stability of the common modern design, it more importantly, creates a space, or storage area, in which to store items such as tools and/or supplies (hereinafter collectively “tools”). The design could also be incorporated into the traditional design for additional strength, such that there is a box-like cross-section inside and outside the rails, which would provide even greater strength and stability. Another variation involves using a removable box that can be slipped inside the storage area and held in place by any number of known means. This removable box can then be used to hold the tools and/or supplies but can also removed and replaced with a second removable box which could be suited for different kinds of tools. This removable box would increase the flexibility and use of the storage ladder. Further incorporated into the storage area, either with or without the removable box, would be a means to fixedly hold the tools such that that ladder could be transported without the necessity to remove the tools. There would also be the option to provide for a door or cover of the storage area to maintain a clean appearance, assist with holding the tools in place and to further provide additional rigidity to the structure. Further, due to the increased weight from the tools, an additional option would wheels or casters that can be incorporated into or fixedly attached to the ladder to facilitate ease of transport.

### BRIEF DESCRIPTION OF THE DRAWING(S)

FIG. 1, shows a drawing of the storage ladder in three-dimensional view with tools affixed thereto. FIG. 2, shows a drawing of one version of the storage ladder from a side view with tools being held in the storage area. FIG. 3 shows a side, top and front view of one version of the storage ladder. FIG. 4 shows a top view of the cross-section of one end of the rail showing the step attached thereto with a storage area insert. FIG. 5, shows a drawing of one version of the retrofit version of the storage ladder, from a side view, with tools being held in the storage area and a cover.

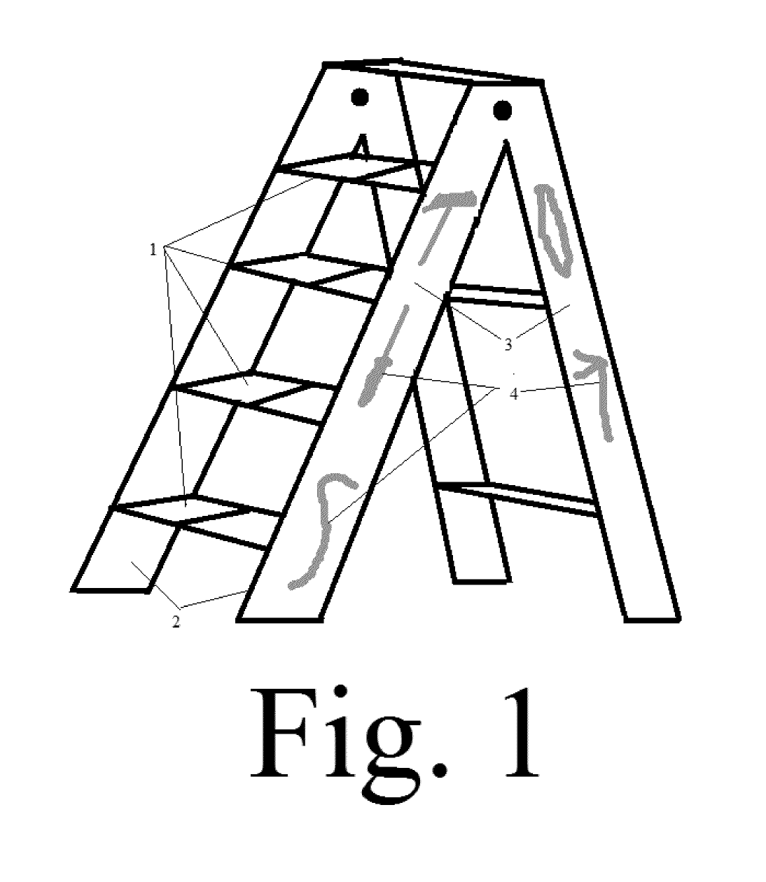

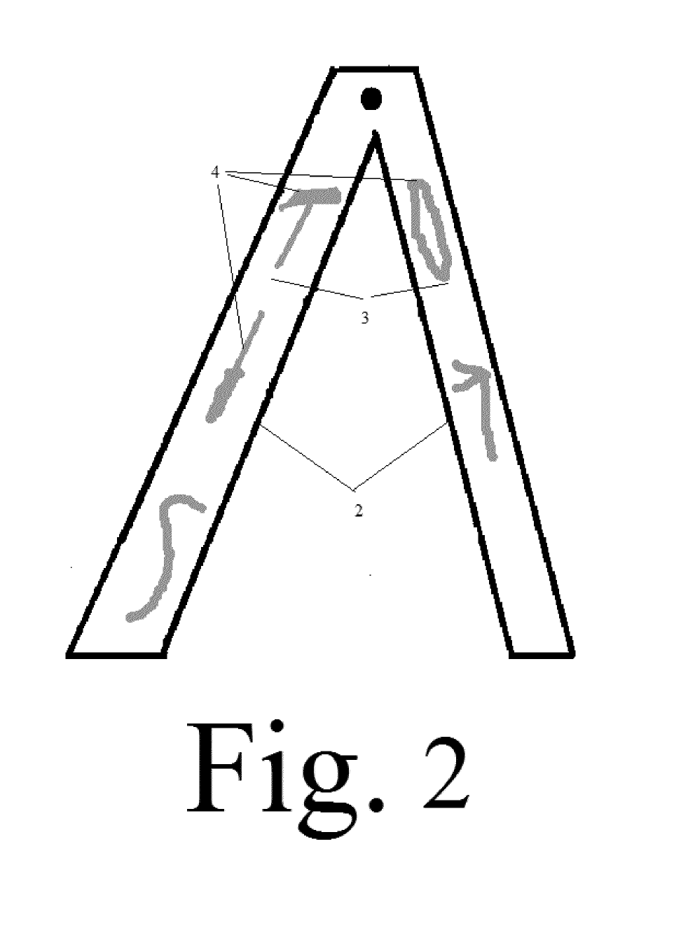

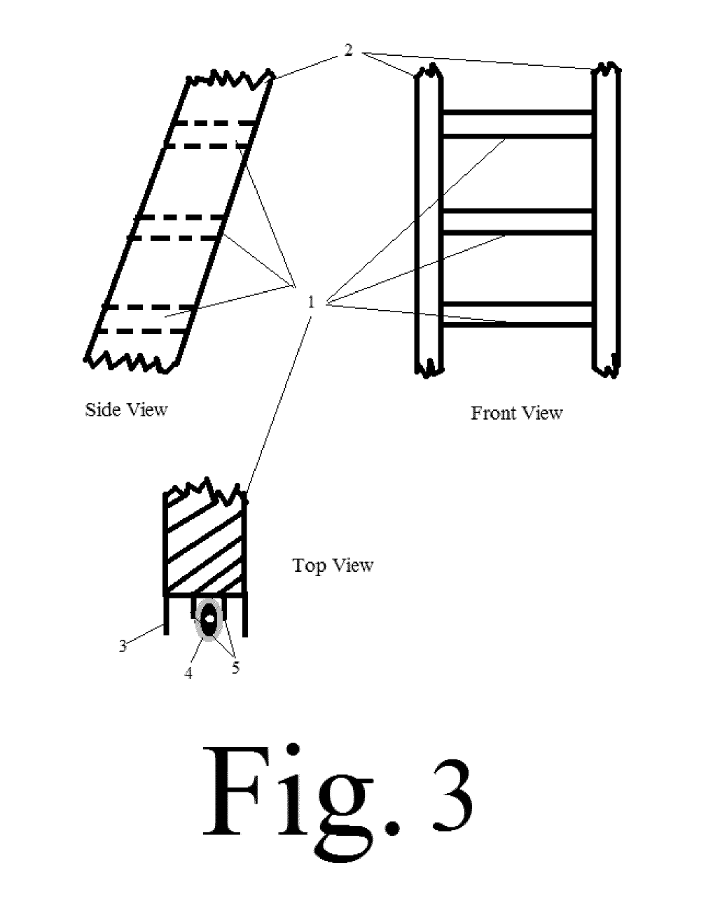

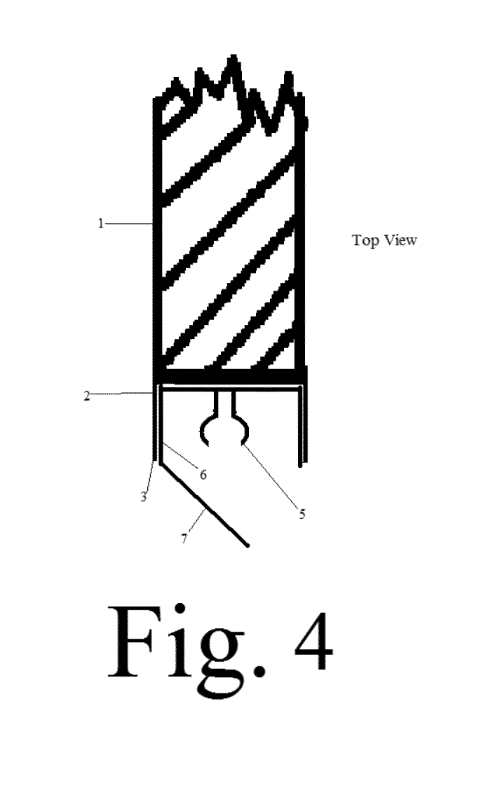

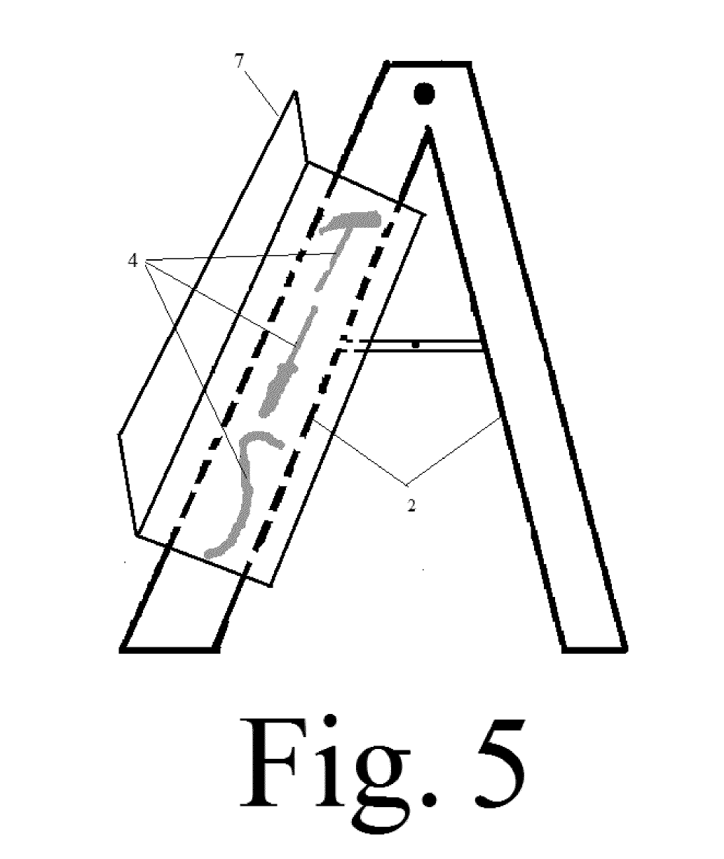

### DESCRIPTION

For the purpose of promoting an understanding of the principles of the present invention, reference will now be made to the embodiment illustrated in specific language contained herein. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

One form of the present invention is a storage ladder whereby the rails, which form the vertical elements of a ladder are of a U shape with the open part of the U pointing outward from the steps. The steps 1 are attached to the inside portion of two rails 2, which are running parallel, as seen in the Figures. This new design for the rails creates an open space 3 which can be used to store tools and other equipment. This rail would be of sufficient width and depth to facilitate the storage of common tools 4, such as hammers, wrenches, screwdrivers but not of a width or depth which would make grabbing or holding the rail (such as when the ladder was being moved or someone was climbing the ladder) difficult or troublesome. An attachment means 5 would also be included within the rails to fixedly hold the tools in place when they are not being used. Another potential option with regard to holding tools, could be a small rectangular removable box 6 as shown in FIG. 4, which can then placed between the newly designed rails, being just slightly smaller than the width of the rail, to facilitate a snug fit, and held in place with clips or rivets. There is also the possibility to incorporate small trays or containers for tools or pieces which are small or numerous. Another potential element of the present invention would be a door or cover 7, as seen in FIG. 4, that would enclose the storage area and could, optionally, be locked. This will help maintain a clean look for the ladder and will further prevent theft of the tools contained therein. Alternatively, the cover could be clear to facilitate viewing of the tools and equipment contained therein. Another potential element of the present invention would be the means to move the ladder without lifting it of the ground. This would be accomplished by incorporating into the manufacturer or attaching thereafter, wheels or casters onto two or more of the end of the rails that are nearest the ground. The wheels or casters would be such that they could be moved out of the way, when not needed.

An additional variation of the invention, as applied to step-ladders, would be to not only have storage capability along the rails which incorporate the steps, but also on the second set of rails, which are the rails that do not include steps and are generally held together with cross-bracing or other supports, and connect with the first set of rails at the top, which creates the ability of the ladder to stand on its own.

Often when someone is employing the use of a ladder it is because there is a need to fix or repair something that is only accessible via a ladder. Traditionally, someone tasked with such a repair would employ the use of a tool-belt or toolbox in which to carry the necessary tools or supplies. The obvious shortcomings with this method is that you would be required to carry more than just the ladder, thus causing additional effort and time in which to make the repair. There is also the possibility of theft of tools or equipment. For example, if one would need to carry a ladder to a location of repair, thus leaving behind tools and equipment, these could be the subject of a theft. A more efficient means would be if only one trip were necessary based upon the fact the ladder incorporated a means to store the tools and equipment. In this way, one would only need to load the ladder with the tools and equipment needed for the job, and then could carry the ladder, along with the tools and equipment, as one unit. Additionally, unlike a tool box, having storage in the ladder means the tools and equipment are within easy reach of the user versus having to go down the ladder to retrieve the necessary equipment. This increases the speed in which the job can be completed and also increases safety by eliminating unnecessary trips up and down a ladder.

A second version of this invention would incorporate two U shaped elements on the rails, back to back, so that each rail, in cross-view, would resemble an I beam. On one side of the rail, the steps would be attached to the first U-shaped section, wrapping slightly around the steps. The second U-shaped section would provide the storage area as described in the first version of the invention. This same area could also be used to put the removable rectangular boxes disclosed in the first version of the invention.

An additional version of this invention could also include a means to plug in electric tools by incorporating into the storage area an electrical outlet or strip. This outlet or strip would be connected to an electrical power source via a cord that is incorporated into the rails and exits such near the bottom thereof. An additional element could be a means for attaching a personal electronic device (phone, Ipod, mp3 player, etc.), with or without external speakers, such that the device and/or speakers are included within the storage area or attached externally to the ladder.

While this invention would be most effective if incorporated into the initial manufacturing process for a ladder, it is possible that such a storage unit can be incorporated into existing ladders as shown in FIG. 5, by simply attaching the U-shaped storage to the existing rails for a ladder. In this case, the size of the storage unit can mimic the width of the rail but it can also be slightly larger, as shown in FIG. 5. Furthermore, a U-shaped storage channel can also be attached, which would then accept the removable rectangular storage units within the channel, as described in the first version of this invention. Additionally, while this invention would prove most helpful for professionals in the trades (plumbing, electrical, painting, carpentry) there would be similar benefits seen by homeowners or other casual users of the invention.

While the invention has been illustrated and described in detail with the foregoing description, the same is to be considered as illustrative and not restrictive in character, it being understood that while the preferred embodiment has been described, that all changes and modifications that come within the spirit of the invention are desired to be protected.

What is claimed is:

1) A storage ladder comprising:
a) a first set of two parallel rails with each having a U-shaped configuration, whereby the U-shaped elements of each are pointed outward from the other;
b) a storage area within the U-shaped configuration of the first set of parallel rails for the storage of tools and equipment;
c) a set of steps fixedly attached at each end to the first set of parallel rails at ninety (90) degrees such that on the end of each step is a rail, with each step rigidly held in place between the first set of parallel rails;
d) a second set of two parallel rails, connected to the first set of parallel rails, at one end of each rail, such that one parallel rail from the second set is attached to one parallel rail from the second set, whereby the second set of parallel rails is attached to the other via a set of cross-braces which are attached near the top of one of the rails and the bottom of the other, creating an X configuration.

2) The Storage Ladder of claim 1 whereby the storage area has a door or cover over it which could be locked and/or could be transparent.

3) The Storage Ladder of claim 1 whereby the second set of parallel rails is in a U-shaped configuration and contains a storage area, just as the one contained in the first set of parallel rails.

4) The Storage Ladder of claim 1 whereby the storage area also includes an electrical outlet in which electric tools can be plugged.

5) The Storage Ladder of claim 1 further comprising a removable rectangular box, which can slip snugly into the storage area and fixedly attached thereto, whereby this removable box can hold tools or equipment, but can also be replaced with a different removable rectangular box which might carry different tools or equipment.

6) The Storage Ladder of claim 1 further comprising a means within the storage area to temporarily fixedly attach or carry tools or equipment such that they do not move when the invention is transported.

7) The Storage Ladder of claim 1 further comprising a means to attach a personal electronic device (phone, Ipod, mp3 player, etc.), with or without external speakers, such that the device and/or speakers are included within the storage area or attached externally to the invention.

8) A storage ladder comprising:
a) a first set of two parallel rails with each having a U-shaped configuration, whereby the U-shaped elements of each are pointed outward from the other;
b) a storage area within the U-shaped configuration of the first set of parallel rails for the storage of tools and equipment;
c) a set of steps fixedly attached at each end to the first set of parallel rails at ninety (90) degrees such that on the end of each step is a rail, with each step rigidly held in place between the first set of parallel rails;
d) a second set of two parallel rails, connected to the first set of parallel rails, such that they are behind the first set of parallel rails and can move along the first set of parallel rails at various heights;
e) a set of steps fixedly attached at each end to the second set of parallel rails at ninety (90) degrees such that on the end of each step is a rail, with each step rigidly held in place between the second set of parallel rails.

9) The Storage Ladder of claim 8 whereby the storage area has a door or cover over it which could be locked and/or could be transparent.

10) The Storage Ladder of claim 8 further comprising a removable rectangular box, which can slip snugly into the storage area and fixedly attached thereto, whereby this removable box can hold tools or equipment, but can also be replaced with a different removable rectangular box which might carry different tools or equipment.

11) The Storage Ladder of claim 8 whereby the second set of parallel rails is in a U-shaped configuration and contains a storage area, just as the one contained in the first set of parallel rails.

12) The Storage Ladder of claim 8 whereby the storage area also includes an electrical outlet in which electric tools can be plugged.

13) The Storage Ladder of claim 8 further comprising a means within the storage area to temporarily fixedly attach or carry tools or equipment such that they do not move when the invention is transported.

14) The Storage Ladder of claim 8 further comprising a means to attach a personal electronic device (phone, Ipod, mp3 player, etc.), with or without external speakers, such that the device and/or speakers are included within the storage area or attached externally to the invention.

15) A storage ladder comprising:
a) a storage area within a long U-shaped configuration, either approximately or slightly larger than the width of the existing rails of a ladder;
b) a means to fixedly attach the storage area to the existing rails of a ladder, either singly or as a set of two or four.

16) The Storage Ladder of claim 15 whereby the ladder is either of a step-ladder variety or an extension ladder variety.

17) The Storage Ladder of claim 15 whereby the storage area has a door or cover over it which could be locked and/or could be transparent.

18) The Storage Ladder of claim 15 whereby the storage area also includes an electrical outlet in which electric tools can be plugged.

19) The Storage Ladder of claim 15 further comprising a means within the storage area to temporarily fixedly attach or carry tools or equipment such that they do not move when the invention is transported.

20) The Storage Ladder of claim 15 further comprising a means to attach a personal electronic device (phone, Ipod, mp3 player, etc.), with or without external speakers, such that the device and/or speakers are included within the storage area or attached externally to the invention.

21) The Storage Ladder of claim 15 further comprising a removable rectangular box, which can slip snugly into the storage area and fixedly attached thereto, whereby this removable box can hold tools or equipment, but can also be replaced with a different removable rectangular box which might carry different tools or equipment.
